(19) United States
(12) Patent Application Publication
(10) Pub. No.: US 2026/0231988 A1
(43) Pub. Date: Aug. 13, 2026

(54) EMULSIONS WITH WATER INSOLUBLE FUNCTIONAL INGREDIENTS

(71) Applicant: THE COCA-COLA COMPANY, Atlanta, GA (US)

(72) Inventors: Jigar RATHOD, Atlanta, GA (US); Bin WANG, Atlanta, GA (US); Sha ZHANG, Atlanta, GA (US); Brian B. JOHNSON, Atlanta, GA (US)

(21) Appl. No.: 19/151,493

(22) PCT Filed: Feb. 16, 2024
(86) PCT No.: PCT/US2024/016225

§ 371 Date: Jul. 28, 2025

Related U.S. Application Data
(60) Provisional application No. 63/446,114, filed on Feb. 16, 2023.

(51) Int. Cl. A23L 2/56; A23L 2/38; A23L 2/58

(52) U.S. Cl. CPC A23L 2/56; A23L 2/38; A23L 2/58

(57) ABSTRACT

The present disclosure provides for an emulsion comprising a sucrose ester, a second emulsifier, and a functional ingredient. Also provided are formulations of the disclosed emulsions with a beverage base. Beverages comprising the disclosed emulsions and methods of making them are also described.

### CROSS REFERENCE TO RELATED APPLICATIONS

This application claims the benefit of priority to U.S. Provisional Application No. 63/446,114, filed Feb. 16, 2023, which is incorporated by reference herein in its entirety.

### BACKGROUND

Numerous flavors, colors, and other such functional ingredients used in beverages and beverage processing are not water soluble and thus require a delivery system such as an emulsion. Traditional emulsions are often cloudy and can be a challenging delivery system for many beverages that are clear. Additionally, some emulsions can be unstable and coalesce, especially at high concentrations. Thus, it can be difficult to include certain ingredients in beverages via emulsions and still have a clear and stable product.

For example, a particular ingredient that is not water soluble is vitamin E. Traditional vitamin E made using acacia or modified starch has poor physical stability and, as such, is difficult to include as an ingredient in beverages. Also, the poor physical stability of vitamin E can require the addition of weighting agents to beverage emulsions to improve the stability. Commercial vitamin E emulsions show physical separation at 40° C. during storage shelf-life studies, thus proving difficult to use in beverages. Other water-insoluble antioxidants like beta-carotene, fish oils, and vitamin D have similar challenges when incorporating into beverages.

Additionally, some beverages can be prepared by taking ingredients stored in highly concentrated containers and then diluting them when making the beverage. Storing water insoluble ingredients in emulsion form at high concentration creates additional challenges when such ingredients are used in beverage formation.

What are thus needed are compositions and methods for including water-insoluble antioxidants, flavors, colorants, or other such functional ingredients into beverages as a stable emulsion, even when at very high concentrations, without significantly affecting clarity of the final beverage. The compositions and methods disclosed herein address these and other needs.

### SUMMARY

In accordance with the purposes of the disclosed materials and methods, as embodied and broadly described herein, the disclosed subject matter, in one aspect, relates to emulsions and methods of preparing and using emulsions. In one example, disclosed are emulsions comprising a first emulsion, a second emulsifier, and a functional ingredient like one or more of an antioxidant, flavoring compound, colorant, or mouth feel agent. The first emulsifier can be a water-soluble emulsifier, the second emulsifier can be a water-insoluble emulsifier, and the functional ingredient can be water-insoluble antioxidant. In some examples, the first emulsifier can be a sucrose ester. In other examples, the first emulsifier can be a Quillaja saponaria extract. In a further example, a beverage is provided, including an emulsion as described herein.

The emulsions disclosed herein can be transparent and advantageously, do not require weighting agents or polysorbate. Further, the disclosed emulsions can have improved physical stability in comparison to previous emulsions and there can be improved bioavailability of the active ingredient. By using Quillaja saponaria extract or sucrose esters, stable emulsions can be made free of polysorbate.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURE

The accompanying figure, which is incorporated in and constitutes a part of this specification, illustrates several aspects of the disclosure, and together with the description, serves to explain the principles of the disclosure.

FIG. 1 is a schematic of a process for making an emulsion as described herein.

FIG. 2 is a group of photographs of Vitamin E nano-emulsion trials from Tables 1 and 2.

FIG. 3 is a group of photographs of Vitamin E nano-emulsion trials from Table 2.

FIG. 4 is a group of photographs of various Vitamin E nano-emulsions from Table 3. Image 1—V21 sample with 1.5% ascorbic acid was cloudy with particles, did not completely dissolved. V22 sample with 1.5% Type 1 anti-foam helped to reduce foam slightly when compared to sample V21 but slightly more viscous. Image 2—Sample V22 with anti-foam helped to reduce foam slightly when compared to the control and sample V23. V22 with anti-foam is cloudier than the other two samples. Image 3—After 12 hrs, the control sample was clearer while the sample with anti-foam still cloudy and has more yellowish color.

FIG. 5 is a group of photographs of Vitamin E nano-emulsions from Table 3.

FIG. 6 is a group of photographs of Vitamin E nano-emulsions from Table 4.

FIG. 7 is a group of photographs of Vitamin E nano-emulsions from Table 4.

FIG. 8 is a group of photographs of Vitamin E nano-emulsions from Table 5.

FIG. 9 is a group of photographs of different sucrose esters (SE). Trial V19 with Type 3 SE looks the clearest.

FIG. 10 is a group of photographs of Vitamin E nano-emulsions from tables 1-5.

FIG. 11 is a photograph of various emulsion formulations after a stability study.

FIG. 12A shows size distributions of freshly made nanoemulsions with 4-5% flavor oil. FIG. 12B shows size distributions of nanoemulsion stored for 3-5 months.

FIG. 13 shows change of size distribution during freeze-defrost process for fatty acid nanoemulsions.

FIG. 14 shows the size distribution of freshly made nanoemulsions and after 2 months of storage.

FIG. 15 shows the size distribution of a nanoemulsion before and after UHT.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound” or “a composition”, includes, but is not limited to, two or more such compounds or compositions, and the like.

As used herein, the term “substantially free,” when used in the context of a composition or component of a composition that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the composition.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

It should be noted that ratios, concentrations, amounts, and other numerical data can be expressed herein in a range format. It can be further understood that the endpoints of each of the ranges are significant both in relation to the other endpoint, and independently of the other endpoint.

### Composition

Provided herein is an emulsion comprising a sucrose ester, a second emulsifier, and an antioxidant.

“Emulsion” is used herein to mean any heterogenous system that contains a liquid disperse phase and continuous phase. The term is not intended to be limited by the particular size of the dispersed phase droplets or particles. The term “emulsion” used herein includes microemulsions and nano-emulsions unless otherwise stated.

“Dispersed phase” refers to the phase existing as droplets. In the context of an oil-in-water emulsion, the dispersed phase is the “oil”. Examples of oils that are suitable for use in herein are one or more saturated or polyunsaturated fatty acids (PUFAs), or a salt or ester derivative thereof, as described elsewhere herein. Fatty acids can be in their free acid form, salt form, triacylglycerol ester form, phytosterol ester, and/or methyl or ethyl ester form and the term “oil” can include any one or more of these forms.

“Continuous phase” references the liquid that surrounds the dispersed phase, or droplets, in the emulsion. The dispersed phase is immiscible in the continuous phase.

### Emulsifier

Emulsifiers as used in food products elsewhere as well as in the compositions and methods disclosed herein include additives that stabilize the dispersion of a dispersed phase in a continuous phase. A number of emulsifiers are derived from algae, among them algin, carrageenan, and agar. Lecithins, such as those found in egg yolk, are also used as emulsifiers. Emulsifiers can include a hydrophobic portion, such as a long-aliphatic chain, and a hydrophilic portion, such as a carboxylic acid, ester, ether, alcohol, amine, or phosphate, that can be either charged or uncharged. Emulsifiers are thus often amphiphilic.

The hydrophobic portion of the emulsifier dissolves in the oil phase and the hydrophilic portion dissolves in the aqueous phase, which forms a dispersion of small oil droplets. Thus, emulsifiers can stabilize oil-in-water emulsions, uniformly disperse oil-soluble flavor compounds throughout a product, prevent large ice-crystal formation in frozen products, and improve the volume, uniformity, and fineness of products. In some embodiments, the emulsifier is in the continuous or dispersed phase.

Emulsifiers can be natural or synthetic. One type of natural emulsifier is a hydrocolloid, which includes locust bean gum, guar gum, gellan gum, carrageenan, pectin, and starch, while animal-sourced hydrocolloids include chitosan made from crustacean shells.

Suitable emulsifiers can also include PEG derivatives having similar properties, for example, PEG derivatives of sterols, e.g., a cholesterol or a sitosterol, and PEG-derivatives of other fat-soluble vitamins, for example, some forms of vitamin A (e.g., Retinol) or vitamin D (e.g., vitamin DI-D5).

### First Emulsifier

In some examples, a first emulsifier is used in the disclosed compositions. The first emulsifier can be a water-soluble emulsifier. Thus, the first emulsifier is found primarily in the continuous phase of the disclosed emulsions. The first emulsifier can be present in the disclosed emulsions at from 0.5 to 10 wt. %. For example, the first emulsifier can be present at from 0.5, 1, 1.5, 2, 2.5, 3, 3.5, 4, 4.5, 5, 5.5, 6, 6.5, 7, 7.5, 8, 8.5, 9, 9.5, or 10 wt. % where any of the stated values can form an upper or lower endpoint as appropriate.

In one example, the first emulsifier can be a sucrose ester. As used herein, sucrose ester is a type of emulsifier. Sucrose esters can be derived from natural products or made synthetically. The natural products from which sucrose ester can be derived include, but are not limited to, Physalis spp., Bidens parviflora, Nicotina tabacum, Equisetum hiemale L., or any combination thereof. Sucrose esters can be synthetically made by methodologies which include transesterification. In some examples, sucrose esters can impact physiological activities such as anti-inflammatory activity, cytotoxic activity, antioxidant activity, or microbiological activity. In further examples, types of sucrose esters may include sucrose monoester, sucrose diester, sucrose triester, sucrose tetraester, sucrose pentaester, sucrose hexaester, sucrose heptaester, sucrose octaester, or any combination thereof. In some examples, sucrose ester can have the following formula:

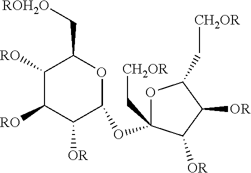

wherein each R is, independently of the others, a fatty acid ester moiety or H, where not all R's are H. In specific examples, one or more R groups are —C(O)C₁₂-C₂₂ alkyl and/or alkenyl groups. In certain examples, the sucrose ester can include sucrose monoester, i.e., one R is a fatty acid ester moiety (—C(O)C₁₂-C₂₂ alkenyl and/or alkenyl group) and all other R's are H.

In another example, the first emulsifier can be a Quillaja Saponaria extract. Quillaja Saponaria, also known as the soap bark tree or soapbark, is an evergreen tree native to warm temperate central Chile. Aqueous extracts from the inner bark of Quillaja Saponaria can be prepared. Some examples of Quillaja Saponaria extract can include p-coumaroyl sucrose esters.

### Second Emulsifier

In the disclosed emulsions, there is a second emulsifier used in combination with the first emulsifier. The second emulsifier can be a water insoluble, oil soluble emulsifier. Thus, the second emulsifier is found primarily in the dispersed phase of the disclosed emulsions. The second emulsifier can be present in the disclosed emulsions at from 0.1 to 2 wt. %. For example, the second emulsifier can be present at from 0.1, 0.2, 0.3, 0.4, 0.5, 0.6, 0.7, 0.8, 0.9, 1, 1.25, 1.5, and 2 wt. % where any of the stated values can form an upper or lower endpoint as appropriate.

In some examples, the second emulsifier can include lecithin. In further examples, the lecithin is derived from a plant. In certain examples, the plant is in the Helianthus genus. In specific examples, the plant is Helianthus annuus. In other examples, lecithin can be derived from is derived from soybean, egg yolk, liver dairy, meat avocados, cabbage, or any mixture thereof.

As used herein, lecithin is a type of emulsifier. Lecithin can include acetone-insoluble phosphatide, wherein the phosphatides include phosphatidyl-choline, phosphatidyl-ethanolamine, and phosphatidyl-inosital, combined with other substances such as triglycerides, fatty acids, and carbohydrates. Depending on the refined grade of lecithin and the fractionations used, lecithin can include any of these components in varying proportions and combinations. In some examples, lecithin can be oil-free, in which case most triglycerides and fatty acids are removed, and the lecithin comprises 90% or more of phosphatides. Lecithin can be prepared from oil-bearing seeds used for food, which can include, but is not limited to, soybeans. In some examples, lecithin may be prepared from animal sources.

Types of lecithin include, but are not limited to, soy lecithin, sunflower lecithin, canola lecithin, animal fat lecithin, fish lecithin, egg lecithin, dairy lecithin, meat lecithin, liver lecithin, corn lecithin, avocado lecithin, cabbage lecithin. Soy lecithin is derived from soybeans, while sunflower lecithin is derived from sunflowers, which includes, but is not limited to, Helianthus annuus, also known as the common sunflower.

The second emulsifier can be used with the first emulsifier at a ratio of 1:1. In other examples, the ratio of the second emulsifier to the first emulsifier can be from 1:10 to 10:1, e.g., 1:10, 2:10, 3:10, 4:10, 5:10, 6:10, 7:10, 8:10, 9:10, 10:1, 10:2, 10:3, 10:4, 10:5, 10:6, 10:7, 10:8, or 10:9, where any of the stated values can form an upper or lower endpoint of a range.

### Functional Ingredients

The disclosed emulsions can have a variety of materials in the dispersed phase. Typically such dispersed phase materials are hydrophobic materials, such as oils and fats and derivatives thereof. In particular examples, the dispersed phase comprises a functional ingredient for a beverage. Examples of such functional ingredients include, but are not limited to, antioxidants, flavors, colorants, and mouth feel enhancers. Further examples of suitable functional ingredients are disclosed herein. Moreover, it is understood that some components can have more than one function, e.g., a compound may be an antioxidant and also a flavor, a compound can be a flavor and also a colorant, and so forth. Still further, multiple functional ingredients disclosed herein can be used together in the disclosed emulsions.

The water insoluble functional ingredient can be present in the disclosed emulsions at from 1 to 10 wt. %. For example, the water insoluble antioxidant can be present at from 1, 2, 3, 4, 5, 6, 7, 8, 9, or 10 wt. % where any of the stated values can form an upper or lower endpoint as appropriate.

### Antioxidant

Antioxidants can decrease oxidative damage by reacting with free radicals, inhibiting the activity or expression of free radical generating enzymes, or enhancing the activity or expression of intracellular antioxidant enzymes. Free radicals are parts of groups of molecules called reactive oxygen species (ROS), reactive nitrogen species (RNS), and reactive sulfur species (RSS). Reactive oxygen species are a result of biological oxidation and when they are at a high level, can cause significant cellular damage in the body. More specifically, this damage can contribute to ailments that include, but are not limited to, inflammatory disease, cardiovascular disease, cancer, diabetes, and Alzheimer's disease. Antioxidants prevent oxidation of molecules inside cells, and in turn, can fight the buildup of free radicals in the body to help prevent damage in the body.

In the disclosed emulsions, the antioxidant can be a water insoluble antioxidant. In some examples, antioxidants include vitamin C, vitamin E, fish oils, vitamin D, and carotenoids (e.g., beta-carotene). Antioxidants can also include flavonoids, tannins, phenols, and lignans. In some examples, the antioxidant can be CoQ₁₀, tocopherols, lipid soluble derivatives of more polar antioxidants such as ascobyl fatty acid esters (e.g., ascobyl palmitate), plant extracts (e.g., rosemary, sage and oregano oils), algal extracts, or synthetic antioxidants (e.g., BHT, TBHQ, ethoxyquin, alkyl gallates, hydroquinones, tocotrienols). In further examples, the antioxidant can be present in either the continuous phase and/or the dispersed phase.

In other examples, some water-soluble antioxidants, such as ascorbic acid and salts thereof, can be in the continuous phase as well.

### Vitamin E

In some examples, the antioxidant can include vitamin E. In further examples, vitamin E comprises D-α-tocopherol. In further examples, the D-α-tocopherol is derived from sunflower oil, soybean oil, or any combination thereof. In certain examples, the vitamin E comprises DL-α-tocopheryl acetate. In specific examples, the emulsion comprises 4.5% of DL-α-tocopheryl acetate by weight of the emulsion.

Vitamin E is a type of antioxidant. Vitamin E is a fat-soluble vitamin that can act as an antioxidant and scavenge loose electrons, like free radicals, that can damage cells. Vitamin E can also enhance immune function and prevent clots from forming in heart arteries. Vitamin E can protect cells from free radical damage and reduce the production of free radicals in certain situations. Vitamin E can be found in various foods, added to other foods, or used in commercially available products as a dietary supplement. In some examples, the dispersed phase of the emulsion comprises vitamin E.

Vitamin E can come in several forms, but a-tocopherol is the only form of vitamin E that is used by the human body. Alpha-tocopherol can be used by the human body to meet appropriate dietary requirements. Alpha-tocopherol can be indicated for dietary supplementation in individuals who may demonstrate a deficiency in vitamin E. One particular stereoisomer of a-tocopherol is D-α-tocopherol, which is the natural formation of a-tocopherol and can exhibit the greatest bioavailability out of all the a-tocopherol stereoisomers.

D-α-tocopherol has the following formula:

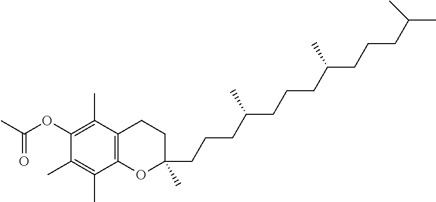 [SMILES: CC(=O)Oc1c(C)c(C)c2c(c1C)CC[C@@](C)(CCC[C@H](C)CCC[C@H](C)CCCC(C)C)O2]

DL-α-tocopheryl acetate is a synthetic racemic mixture of a-tocopherol. It is less bioavailable and potent than D-α-tocopherol. In some examples, DL-α-tocopheryl acetate is synthetically produced from petrochemicals.

DL-α-tocopheryl acetate has the following formula:

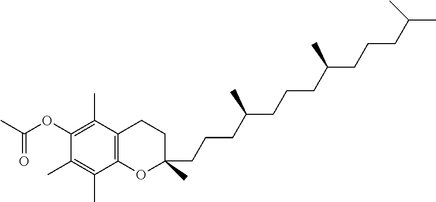 [SMILES: CC(=O)Oc1c(C)c(C)c2c(c1C)CC[C@](C)(CCC[C@@H](C)CCC[C@@H](C)CCCC(C)C)O2]

The water insoluble antioxidant can be present in the disclosed emulsions at from 1 to 10 wt. %. For example, the water insoluble antioxidant can be present at from 1, 2, 3, 4, 5, 6, 7, 8, 9, or 10 wt. % where any of the stated values can form an upper or lower endpoint as appropriate.

### Flavors/Flavor Oils.

One or more flavors can be used as the dispersed phase of the disclosed emulsions. Flavors suitable for the disclosed emulsions can be water insoluble and can be chosen from synthetic flavors, flavoring oils and oil extracts derived from plants, leaves, flowers, fruits and combinations thereof. Examples of suitable flavors are selected from natural cinnamon oil, peppermint oil, clove oil, bay oil, thyme oil, also from artificial, natural or synthetic fruit flavors such as vanilla, chocolate, coffee, cocoa and citrus oil, including lemon, lime, orange, grape, grapefruit, and fruit essences including apple, pear, peach, strawberry, watermelon, raspberry, cherry, plum, pineapple and apricot. Botanical flavors can be used and can include, for example, tea (black, white, red and green tea), aloe vera, guarana, ginseng, ginkgo, hawthorn, hibiscus, rose hips. The flavors can also comprise a blend of various flavors. Still other exemplary flavor compounds include allyl caproate, benzaldehyde, ethyl butyrate, limonene, citral, geranyl acetate, neryl acetate, octanal, nonanal, decanal, vanillin, ocimene, alpha ionone, beta ionone, maltol, furaneol, gamma-decalactone, gamma-octalactone ethyl acetate, linalool, hexyl acetate, cinnamaldehyde, citronellal, nerol, geraniol, alpha terpineol, valencene, (E,Z)-2,6-nonadienal and (E)-2-nonenal.

The flavors can be present in the disclosed emulsions at from 1 to 10 wt. %. For example, the flavors can be present at from 1, 2, 3, 4, 5, 6, 7, 8, 9, or 10 wt. % where any of the stated values can form an upper or lower endpoint as appropriate.

### Colorants

One or more colorants can be used as the dispersed phase of the disclosed emulsions. Colorants suitable for the disclosed emulsions can include FD&C dyes (e.g., yellow #5, blue #2, red #40). Riboflavin and β-carotene may also be used. Additionally, other natural coloring agents may be utilized including, for example, fruit, vegetable, and/or plant extracts such as grape, black currant, aronia, carrot, beetroot, red cabbage, and hibiscus.

The colorants can be present in the disclosed emulsions at from 1 to 10 wt. %. For example, the colorants can be present at from 1, 2, 3, 4, 5, 6, 7, 8, 9, or 10 wt. % where any of the stated values can form an upper or lower endpoint as appropriate.

### Mouth Feel Enhancers

One or more mouth feel enhancers can be used in the disclosed emulsions. In certain embodiments, the mouth feel enhancer is at least one fatty acid. The at least one fatty acid may be single fatty acid or a plurality of fatty acids.

As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use herein can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof.

The mouth feel enhancers can be present in the disclosed emulsions at from 1 to 10 wt. %. For example, the mouth feel enhancers can be present at from 1, 2, 3, 4, 5, 6, 7, 8, 9, or 10 wt. % where any of the stated values can form an upper or lower endpoint as appropriate.

### Beverage Base

The disclosed formulations comprise emulsions as disclosed herein with a beverage base as the continuous phase. Beverage bases are reconstituted with a diluent (such as water) to form a beverage. Beverage bases can be a syrup, concentrate, and other forms of liquids containing concentrated ingredients used in the manufacturing of beverages. Suitable beverage bases usually have a diluent reconstitution ratio of 5:1 to 500:1, e.g., 15:1 to 400:1, 30:1 to 300:1, 49:1 to 151:1, more specifically at 50:1, 55:1, 60:1, 65:1, 70:1, 75:1, 76:1, 80:1, 85:1, 90:1, 95:1, 100:1, 105:1, 110:1, 115:1, 120:1, 125:1, 126:1, 130:1, 135:1, 140:1, 145:1, 150:1, 151:1 where any of the stated ratios can be upper or lower endpoints of a range of ratios. The viscosity of the beverage base may range from about 1 to about 10,000 centipoise and generally over 100 centipoises when chilled.

The disclosed emulsions can be present in the beverage base at from 0.15 to 30 wt. %, e.g., at 0.5, 1, 2, 5, 10, 15, or 30 wt. %, where any of the stated values can form an upper or lower endpoint of a range.

### Micro-Emulsion

A microemulsion is a thermodynamically stable emulsion. In some examples, the emulsion is a micro-emulsion. A micro-emulsion is used to refer to a specific type of emulsion where the size of the particles or droplets in the dispersed phase is below 100 nanometers.

In some examples, the emulsion can have an average particle size of 100 nm or less, 90 nm or less, 80 nm or less, 70 nm or less, 60 nm or less, 50 nm or less, 40 nm or less, 30 nm or less, 20 nm or less, or 10 nm or less. In further examples, the emulsion can have an average particle size of from 100 nm to 90 nm, 100 nm to 80 nm, 100 nm to 70 nm, 100 nm to 60 nm, 100 nm to 50 nm, 100 nm to 40 nm, 100 nm to 30 nm, 100 nm to 20 nm, 100 nm to 10 nm, or 100 nm to 1 nm. In certain examples, the emulsion can have an average particle size of from 60 nm to 100 nm.

### Nano-Emulsion

A nanoemulsion is a thermodynamically unstable emulsion. In some examples, the emulsion is a nano-emulsion. A nano-emulsion is used to refer to a specific type of emulsion where the size of the particles or droplets in the dispersed phase is typically less than 0.1 μm or less than 100 nanometers. The size of the particle droplets in the dispersed phase disclosed herein can be measured by dynamic light scattering.

In some examples, the emulsion can have an average particle size of 100 nm or less, 90 nm or less, 80 nm or less, 70 nm or less, 60 nm or less, 50 nm or less, 40 nm or less, 30 nm or less, 20 nm or less, or 10 nm or less. In further examples, the emulsion can have an average particle size of from 100 nm to 90 nm, 100 nm to 80 nm, 100 nm to 70 nm, 100 nm to 60 nm, 100 nm to 50 nm, 100 nm to 40 nm, 100 nm to 30 nm, 100 nm to 20 nm, 100 nm to 10 nm, or 100 nm to 0 nm. In certain examples, the emulsion can have an average particle size of from 0 nm to 10 nm, 0 nm to 20 nm, 0 nm to 30 nm, 0 nm to 40 nm, 0 nm to 50 nm, 0 nm to 60 nm, 0 nm to 70 nm, 0 nm to 80 nm, 0 nm to 90 nm, or 0 nm to 100 nm. In specific examples, the emulsion can have an average particle size of from 0 nm to 10 nm, nm to 20 nm, 20 nm to 30 nm, 30 nm to 40 nm, 40 nm to 50 nm, 50 nm to 60 nm, 60 nm to 70 nm, 70 nm to 80 nm, 80 nm to 90 nm, or 90 nm to 100 nm. In some examples, the 10 emulsion can have an average particle size of from 0 nm to 25 nm, 25 nm to 50 nm, 50 nm to 75 nm, or 75 nm to 100 nm.

In further examples, the emulsion can have an average particle size of from 50 nm to 52 nm, 52 nm to 54 nm, 54 nm to 56 nm, 56 nm to 58 nm, or 58 nm to 60 nm. In certain examples, the emulsion can have an average particle size of from 50 nm to 55 nm or 55 nm to 60 nm. In specific examples, the emulsion can have an average particle size of 50 nm to 51 nm, 50 nm to 52 nm, 50 nm to 53 nm, 50 nm to 54 nm, 50 nm to 55 nm, 50 nm to 56 nm, 50 nm to 57 nm, 50 nm to 58 nm, 50 nm to 59 nm, or 50 nm to 60 nm.

### Stable

The disclosed compositions can be stable emulsions. Stability can relate to various physical changes that can occur in food products and affect the quality of the food products, which includes beverages. These physical changes can include changes such as melting, crystallization, phase separations, or any combination thereof. In some examples, a stable beverage can include a beverage that is particle stabilized, emulsion stabilized, or protein stabilized, for example. A beverage is particle stabilized when the particles, such as pulps, cacao particles, and minerals, are evenly suspended throughout the beverage. A beverage is emulsion stabilized when there is no oil or fat ring on the top of the beverage container or bottle. A beverage is protein stabilized when the proteins in the beverage have not flocculated, not become sediment, and the beverage exhibits a smooth mouth feel. In further examples, stable can also include stabilization of the texture, which, in addition to the types of stabilization discussed above, includes a homogenous viscosity and appearance throughout the beverage. Homogenous viscosity and appearance can include, but is not limited to, no gel points or lumps, no flocculation, no phase separation, no viscosity gradient, no layer formation, and/or no clarification.

In some examples, the emulsion can be stable for at least 8 weeks at a temperature of 40° C. without forming rings or separation. In certain examples, the emulsion is stable for more than 8 weeks, e.g., 9, 10, 11, or 12 weeks at a temperature of 40° C. without forming rings or separation. Further, the emulsion can be stable at 8 weeks at a temperature of 40° C. and at a concentration of 150 times what is recommended daily value in beverage concentrates.

### Clear

In some examples, the emulsion is clear. “Clear” is used herein to refer to a characteristic of the disclosed emulsions. The clarity of an emulsion can be measured by various methods. However, unless stated otherwise, an emulsion that has an absorbance of less than about 0.1 A of a 1.3 cm thick sample at 400 nm is considered clear. A semi clear emulsion has an absorbance of from 0.3 A to about 0.1 A when measured at 400 nm in a 1.3 cm sample.

### Polysorbate

In some examples, the emulsion is substantially free of a polysorbate. Polysorbates are oily liquids derived from PEGylated sorbitan (a derivative of sorbitol) esterified with fatty acids. Examples of suitable polysorbates are polysorbate 20 (Tween 20 or polyoxyethylene (20) sorbitan monolaurate), polysorbate 40 (Tween 40 or polyoxyethylene (20) sorbitan monopalmitate), polysorbate 60 (Tween 60 or polyoxyethylene (20) sorbitan monostearate), and polysorbate 80 (Tween 80 or polyoxyethylene (20) sorbitan monooleate). The number following the polyoxyethylene part refers to the total number of oxyethylene-(CH₂CH₂O)-groups found in the molecule. The number following the polysorbate part is related to the type of fatty acid associated with the polyoxyethylene sorbitan part of the molecule. Monolaurate is indicated by 20, monopalmitate is indicated by 40, monostearate by 60 and monooleate by 80.

### Weighting Agents

In some examples, the emulsion is substantially free of a weighting agent. Weighting agents are density-adjusting agents that comprise lipophilic compounds with specific gravity higher than water. Types of weighting agents include, but are not limited to, brominated vegetable oil, damar gum, ester gum, and sucrose acetate isobutyrate. In some preferred examples, weighting agents are not used in the disclosed compositions and methods.

### Anti-Foaming Agents

In some examples, the emulsions disclosed herein can have antifoaming agents. The antifoaming agents can be present at from 0.1 to 2 wt. %, e.g., at 0.1, 0.3, 0.5, 0.7, 1, 1.3, 1.5, 1.7, or 2 wt. %, where any of the stated values can form an upper or lower endpoint of a range.

### Polydispersity Index

In some examples, the emulsion has a polydispersity index of from 0.100 to 0.150. In further examples, the emulsion has a polydispersity of from 0.120 to 0.130. The polydispersity index (PDI) is a measure of the heterogeneity of a sample based on size. Polydispersity can occur due to size distribution in a sample or agglomeration or aggregation of the sample during isolation or analysis. The formula for calculating PDI is as follows:

$$\frac{{M}_{w}}{{M}_{n}} = P D I$$

wherein M_{w} is the weight-average degree of polymerization and Mₙ is the number-average degree of polymerization.

In some examples, the emulsion can have a polydispersity index of from 0.100 to 0.110, 0.110 to 0.120, 0.120 to 0.130, 0.130 to 0.140, or 0.140 to 0.150. In further examples, the emulsion can have a polydispersity index of from 0.100 to 0.110, 0.100 to 0.120, 0.100 to 0.130, 0.100 to 0.140, or 0.100 to 0.150. In certain examples, the emulsion can have a polydispersity index of from 0.100 to 0.125, or 0.125 to 0.150.

In some examples, the emulsion can have a polydispersity index of from 0.120 to 0.121, 0.121 to 0.122, 0.122 to 0.123, 0.123 to 0.124, 0.124 to 0.125, 0.125 to 0.126, 0.126 to 0.127, 0.127 to 0.128, 0.128 to 0.129, or 0.129 to 0.130. In further examples, the emulsion can have a polydispersity index of 0.120 to 0.122, 0.122 to 0.124, 0.124 to 0.126, 0.126 to 0.128, or 0.128 to 0.130. In specific examples, the emulsion can have a polydispersity index of 0.120 to 0.125, or 0.125 to 0.130.

Also provided herein is a beverage comprising the emulsion as described herein. A beverage includes types of drink such as soft drinks, teas, juices, coffee, sports drinks, enhanced water, sparking water, and other beverages. In some examples, the beverages are chilled. In further examples, the beverages can be carbonated. In certain examples, the beverages can include flavoring materials, such as flavored syrups or sweeteners. In the beverage the continuous phase can be the aqueous phase. There can also be other ingredients present, e.g., dissolved, in the aqueous phase like colorants, flavors, electrolytes, amino acids, caffeine, sweeteners, or any combination thereof.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### Method of Use

The formulations disclosed herein, and cartridges containing them, can be used in a beverage dispensing machine. A diluent, such as water or carbonated water, can be mixed with the formulation in the cartridges at reconstitution ratio of from 3:1 to 1000:1, e.g., 15:1 to 400:1, 30:1 to 300:1, 49:1 to 151:1, more specifically at 5:1, 10:1, 50:1, 55:1, 60:1, 65:1, 70:1, 75:1, 76:1, 80:1, 85:1, 90:1, 95:1, 100:1, 105:1, 110:1, 115:1, 120:1, 125:1, 126:1, 130:1, 135:1, 140:1, 145:1, 150:1, 151:1 where any of the stated ratios can be upper or lower endpoints of a range of ratios. In some specific examples, the reconstitution ratio of the emulsions may be 5:1, 30:1, 76:1, 126:1, or 151:1.

A pump or metering device in the beverage dispensing machine may be releasably fluidically coupled to a cartridge with the formulations for supplying the emulsions to a nozzle. The pump or metering device can dispense the formulations at a 0.01% to 6% (e.g., 1%) utilization rate of the emulsions per volume of finished beverage dispensed from the beverage dispensing machine. In a specific example, the beverage dispensing machine may comprise two cartridges with the formulations, each cartridge coupled to a corresponding pump or metering device for dispensing the formulation to the nozzle at a, e.g., 2% total utilization rate of the emulsions per volume of finished beverage dispensed from the beverage dispensing machine. Other utilization rates of the emulsions can be used, such as 0.01% to 6%. In some examples, the utilization rate of the emulsions to the finished beverage can be 0.01%, 0.5%, 0.6%, 0.7%, 0.8%, 0.9%, 1%, 1.5%, 2%, 2.5%, 3%, 3.5%, 4%, 4.5%, 5%, 5.5%, or 6%, where any of the stated values can be the upper or lower endpoint of a range.

A finished beverage may be dispensed from beverage dispensing machine by dispensing formulations in cartridges along with a diluent, e.g., water or carbonated water, with or without any supplemental sweetener or flavor components added to the finished beverage. For example, the beverage may be dispensed from a beverage dispensing machine by only dispensing the formulations in the cartridges along with water or carbonated water. In various implementations, a finished beverage may be dispensed from the beverage dispensing machine by dispensing the formulations in the cartridges along with one or more additional beverage ingredients and water or carbonated water. The additional beverage ingredients may include one or more sweetener(s), and/or micro-ingredient non-sweetener flavor component(s). The sweetener may be selected from one or more nutritive or non-nutritive sweeteners such as sugar syrup, HFCS (“High Fructose Corn Syrup”), FIS (“Fully Inverted Sugar”), MIS (“Medium Inverted Sugar”), erythritol, aspartame, Ace-K, steviol glycosides (e.g., Reb A, Reb M), sucralose, saccharin, or combinations thereof and other flavor and sweetener ingredients. The non-sweetener flavor component may be selected from one or more flavors of a cherry, grape, lemon, lime, orange, peach, raspberry, strawberry, vanilla, or combinations thereof. In some specific examples, the beverage dispensing machine may dispense an un-sweetened, un-flavored beverage; a sweetened, un-flavored beverage; a sweetened, flavored beverage; or an un-sweetened, flavored beverage.

Described herein are example systems and methods for dispensing a beverage in a beverage dispensing system (such as a Coca-Cola® Freestyle®). For example, a beverage dispensing system (which may include one or more macro-ingredients and one or more micro-ingredients) combines macro-ingredients (such as sweeteners, water, or carbonated water) and micro-ingredients (such as high intensity sweeteners, flavorings, food acids, or additives) to create a finished beverage. Such micro-dosing functionality may increase the dispensing capabilities of the beverage dispensing system to deliver a large variety of beverages and improve the quality of the beverage dispensed by the beverage dispensing system, including coffee beverages dispensed using the formulations disclosed herein.

Generally described, the macro-ingredients may have reconstitution ratios in the range from full strength (no dilution) to about six (6) to one (1) (but generally less than about ten (10) to one (1)). As used herein, the reconstitution ratio refers to the ratio of diluent (e.g., water or carbonated water) to beverage ingredient. Therefore, a macro-ingredient with a 5:1 reconstitution ratio refers to a macro-ingredient that is to be dispensed and mixed with five parts diluent for every part of the macro-ingredient in the finished beverage. Many macro-ingredients may have reconstitution ratios in the range of about 3:1 to 10:1, including 4.5:1, 4.75:1, 5:1, 5.25:1, 5.5:1, 6:1, and 8:1 reconstitution ratios.

The macro-ingredients may include sweeteners such as sugar syrup, HFCS (“High Fructose Corn Syrup”), FIS (“Fully Inverted Sugar”), MIS (“Medium Inverted Sugar”), mid-calorie sweeteners comprised of nutritive and non-nutritive or high intensity sweetener blends, and other such nutritive sweeteners that are difficult to pump and accurately meter at concentrations greater than about 10:1-particularly after having been cooled to standard beverage dispensing temperatures of around 35-45° F. An erythritol sweetener may also be considered a macro-ingredient sweetener when used as the primary sweetener source for a beverage, though typically erythritol will be blended with other sweetener sources and used in solutions with higher reconstitution ratios such that it may be considered a micro-ingredient as described below.

The macro-ingredients may also include traditional BIB (“bag-in-box”) flavored syrups (e.g., COCA-COLA® bag-in-box syrup), which contain all of a finished beverage's sweetener, flavors, and acids that when dispensed is to be mixed with a diluent source such as plain or carbonated water in ratios of around 3:1 to 6:1 of diluent to the syrup. Other typical macro-ingredients may include concentrated extracts, purees, juice concentrates, dairy products or concentrates, soy concentrates, and rice concentrates.

The macro-ingredient may also include macro-ingredient base products. Such macro-ingredient base products may include the sweetener as well as some common flavorings, acids, and other common components of a plurality of different finished beverages. However, one or more additional beverage ingredients (either micro-ingredients or macro-ingredients as described herein) other than the diluent are to be dispensed and mix with the macro-ingredient base product to produce a particular finished beverage. In other words, the macro-ingredient base product may be dispensed and mixed with a first micro-ingredient non-sweetener flavor component to produce a first finished beverage. The same macro-ingredient base product may be dispensed and mixed with a second micro-ingredient non-sweetener flavor component to produce a second finished beverage.

The macro-ingredients described above may be stored in a conventional bag-in-box container in, at and/or remote from the dispenser. The viscosity of the macro-ingredients may range from about 1 to about 10,000 centipoise and generally over 10⁰ centipoises or so when chilled. Other types of macro-ingredients may be used herein.

The micro-ingredients may have reconstitution ratios ranging from about ten (10) to one (1) and higher. Specifically, many micro-ingredients may have reconstitution ratios in the range of about 20:1, to 50:1, to 100:1, to 300:1, to 500:1, to 1000:1, or higher. The viscosities of the micro-ingredients typically range from about one (1) to about six (6) centipoise or so, but may vary from this range. In some instances, the viscosities of the micro-ingredients may be forty (40) centipoise or less. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutraceuticals, and similar types of ingredients. Various acids may be used in micro-ingredients including food acid concentrates such as phosphoric acid, citric acid, malic acid, or any other such common food acids. Various types of alcohols may be used as either macro- or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

Typically, micro-ingredients for a finished beverage product include separately stored non-sweetener beverage component concentrates that constitute the flavor components of the finished beverage. Non-sweetener beverage component concentrates do not act as a primary sweetener source for the finished beverage and do not contain added sweeteners, though some non-sweetener beverage component concentrates may have sweet tasting flavor components or flavor components that are perceived as sweet in them. These non-sweetener beverage component concentrates may include the food acid concentrate and food acid-degradable (or non-acid) concentrate components of the flavor, such as described in commonly owned U.S. Pat. No. 10,631,558, entitled “Methods and Apparatus for Making Compositions Comprising and Acid and Acid Degradable Component and/or Compositions Comprising a Plurality of Selectable Components,” which is herein incorporated by reference in its entirety. As noted above, micro-ingredients may have reconstitution ratios ranging from about ten (10) to one (1) and higher, where the micro-ingredients for the separately stored non-sweetener beverage component concentrates that constitute the flavor components of the finished beverage typically have reconstitution ratios ranging from 10:1, 30:1, 49:1, 50:1, 75:1, 100:1, 150:1, 300:1, 500:1, 1000:1, or higher.

For example, the non-sweetener flavor components of a soft drink finished beverage may be provided from separately stored first non-sweetener beverage component concentrate and a second non-sweetener beverage component concentrate. The first non-sweetener beverage component concentrate may comprise the food acid concentrate components of the soft drink finished beverage, such as phosphoric acid. The second non-sweetener beverage component concentrate may comprise the food acid-degradable concentrate components of the soft drink finished beverage, such as flavor oils that would react with and impact the taste and shelf life of a non-sweetener beverage component concentrate were they to be stored with the phosphoric acid or other food acid concentrate components separately stored in the first non-sweetener component concentrate. While the second non-sweetener beverage component concentrate does not include the food acid concentrate components of the first non-sweetener beverage component concentrate (e.g., phosphoric acid), the second non-sweetener beverage component concentrate may still be a high-acid beverage component solution (e.g., pH less than 4.6). In some implementations, the non-sweetener flavor component concentrate of a finished beverage may be provided form a single non-sweetener beverage component concentrate.

A finished beverage may have a plurality of non-sweetener concentrate components of the flavor other than the acid concentrate component of the finished beverage. For example, the non-sweetener flavor components of a cherry soft drink finished beverage may be provided from the separately stored non-sweetener beverage component concentrates described in the above example as well as a cherry non-sweetener component concentrate. The cherry non-sweetener component concentrate may be dispensed in an amount consistent with a recipe for the cherry soft drink finished beverage. Such a recipe may have more, less, or the same amount of the cherry non-sweetener component concentrate than other recipes for other finished beverages that include the cherry non-sweetener component concentrate. For example, the amount of cherry specified in the recipe for a cherry soft drink finished beverage may be more than the amount of cherry specified in the recipe for a cherry lemon-lime finished beverage to provide an optimal taste profile for each of the finished beverage versions. Such recipe-based flavor versions of finished beverages are to be contrasted with the addition of flavor additives or flavor shots as described below.

Other typical micro-ingredients for a finished beverage product may include micro-ingredient sweeteners. Micro-ingredient sweeteners may include high intensity sweeteners such as aspartame, Ace-K, steviol glycosides (e.g., Reb A, Reb M), sucralose, saccharin, or combinations thereof. Micro-ingredient sweeteners may also include erythritol when dispensed in combination with one or more other sweetener sources or when using blends of erythritol and one or more high intensity sweeteners as a single sweetener source.

Other typical micro-ingredients for supplementing a finished beverage product may include micro-ingredient flavor additives. Micro-ingredient flavor additives may include additional flavor options that can be added to a base beverage flavor. The micro-ingredient flavor additives may be non-sweetener beverage component concentrates. For example, a base beverage may be a soft drink flavored beverage, whereas cherry, lime, lemon, orange, and the like may be added to the soft drink beverage as flavor additives, sometimes referred to as flavor shots. In contrast to recipe-based flavor versions of finished beverages, the amount of micro-ingredient flavor additive added to supplement a finished beverage may be consistent among different finished beverages. For example, the amount of cherry non-sweetener component concentrate included as a flavor additive or flavor shot in a soft drink finished beverage may be the same as the amount of cherry non-sweetener component concentrate included as a flavor additive or flavor shot in a lemon-lime finished beverage. Additionally, whereas a recipe-based flavor version of a finished beverage is selectable via a single finished beverage selection icon or button (e.g., cherry soft drink icon/button), a flavor additive or flavor shot is a supplemental selection in addition to the finished beverage selection icon or button (e.g., soft drink icon/button selection followed by a cherry icon/button selection).

As is generally understood, such beverage selections may be made through a touchscreen user interface or other typical beverage user interface selection mechanism (e.g., buttons) on a beverage dispenser. The selected beverage, including any selected flavor additives, may then be dispensed upon the beverage dispenser receiving a further dispense command through a separate dispense button on the touchscreen user interface or through interaction with a separate pour mechanism such as a pour button (electromechanical, capacitive touch, or otherwise) or pour lever.

In the traditional BIB flavored syrup delivery of a finished beverage, a macro-ingredient flavored syrup that contains all of a finished beverage's sweetener, flavors, and acids is mixed with a diluent source such as plain or carbonated water in ratios of around 3:1 to 6:1 of diluent to the syrup. In contrast, for a micro-ingredient delivery of a finished beverage, the sweetener(s) and the non-sweetener beverage component concentrates of the finished beverage are all separately stored and mixed together about a nozzle when the finished beverage is dispensed. Example nozzles suitable for dispensing of such micro-ingredients include those described in commonly owned U.S. Pat. No. 10,472,220, entitled “Dispensing Nozzle Assembly,” U.S. Pat. No. 7,866,509, entitled “Dispensing Nozzle Assembly,” or U.S. Pat. No. 7,578,415, entitled “Dispensing Nozzle Assembly,” which are all herein incorporated by reference in their entirety.

In operation, the beverage dispenser may dispense finished beverages from any one or more of the macro-ingredient or micro-ingredient sources described above. For example, similar to the traditional BIB flavored syrup delivery of a finished beverage, a macro-ingredient flavored syrup may be dispensed with a diluent source such as plain or carbonated water to produce a finished beverage. Additionally, the traditional BIB flavored syrup may be dispensed with the diluent and one or more micro-ingredient flavor additives to increase the variety of beverages offered by the beverage dispenser.

Micro-ingredient-based finished beverages may be dispensed by separately dispensing each of the two or more non-sweetener beverage component concentrates of the finished beverage along with a sweetener and diluent. The sweetener may be a macro-ingredient sweetener and/or a micro-ingredient sweetener and the diluent may be water and/or carbonated water. For example, a micro-ingredient-based soft drink finished beverage may be dispensed by separately dispensing food acid concentrate components of the soft drink finished beverage, such as phosphoric acid, food acid-degradable concentrate components of the soft drink finished beverage, such as flavor oils, macro-ingredient sweetener, such as HFCS, and carbonated water. In another example, a micro-ingredient-based diet-soft drink finished beverage may be dispensed by separately dispensing food acid concentrate components of the diet-soft drink finished beverage, food acid-degradable concentrate components of the diet-soft drink finished beverage, micro-ingredient sweetener, such as aspartame or an aspartame blend, and carbonated water. As a further example, a mid-calorie micro-ingredient-based soft drink finished beverage may be dispensed by separately dispensing food acid concentrate components of the mid-calorie soft drink finished beverage, food acid-degradable concentrate components of the mid-calorie soft drink finished beverage, a reduced amount of a macro-ingredient sweetener, a reduced amount of a micro-ingredient sweetener, and carbonated water. By reduced amount of macro-ingredient and micro-ingredient sweeteners, it is meant to be in comparison with the amount of macro-ingredient or micro-ingredient sweetener used in the soft drink finished beverage and diet-soft drink finished beverage. As a final example, a supplemental flavored micro-ingredient-based beverage, such as a cherry soft drink beverage or a soft drink beverage with an orange flavor shot, may be dispensed by separately dispensing a food acid concentrate components of the flavored soft drink finished beverage, food acid-degradable concentrate components of the flavored soft drink finished beverage, one or more non-sweetener micro-ingredient flavor additives (dispensed as either as a recipe-based flavor version of a finished beverage or a flavor shot), a sweetener (macro-ingredient sweetener, micro-ingredient sweetener, or combinations thereof), and carbonated water. While the above examples are provided for carbonated beverages, they apply to still beverages as well by substituting carbonated water with plain water.

The various ingredients may be dispensed by the beverage dispenser in a continuous pour mode where the appropriate ingredients in the appropriate proportions (e.g., in a predetermined ratio) for a given flow rate of the beverage being dispensed. In other words, as opposed to a conventional batch operation where a predetermined amount of ingredients are combined, the beverage dispenser provides for continuous mixing and flows in the correct ratio of ingredients for a pour of any volume. This continuous mix and flow method can also be applied to the dispensing of a particular size beverage selected by the selection of a beverage size button by setting a predetermined dispensing time for each size of beverage.

### Specific Formulations

In some aspects, the techniques described herein relate to an emulsion, including a sucrose ester, a second emulsifier, and a water-insoluble functional ingredient. In some aspects, the techniques described herein relate to an emulsion, including, a Quillaja saponaria extract, a second emulsifier, and a water-insoluble functional ingredient. In some aspects, the water-insoluble functional ingredient is selected from the group consisting of an antioxidant, a flavor, a colorant, and a mouth feel enhancer.

In some aspects, the techniques described herein relate to an emulsion, wherein the sucrose ester includes sucrose monoester.

In some aspects, the techniques described herein relate to an emulsion, wherein the second emulsifier includes lecithin. In some aspects, the techniques described herein relate to an emulsion, wherein the lecithin is derived from a plant. In some aspects, the techniques described herein relate to an emulsion, wherein the plant belongs to genus Helianthus. In some aspects, the techniques described herein relate to an emulsion, wherein the plant is Helianthus annuus. In some aspects, the techniques described herein relate to an emulsion, wherein the lecithin is derived from soybean, sunflower, canola, egg yolk, liver, dairy, meat, avocados, cabbage, or any mixture thereof.

In some aspects, the techniques described herein relate to an emulsion, functional ingredient includes vitamin E, fish oil, beta-carotene, vitamin D, or a mixture thereof. In some aspects, the techniques described herein relate to an emulsion, wherein the vitamin E includes D-α-tocopherol, DL-α-tocopheryl acetate, or a combination thereof.

In some aspects, the techniques described herein relate to an emulsion, wherein the emulsion is a micro-emulsion. In some aspects, the techniques described herein relate to an emulsion, wherein the emulsion is a nano-emulsion.

In some aspects, the techniques described herein relate to an emulsion, wherein the emulsion is stable for at least 8 weeks at a temperature of 40° C. without forming a ring or separating.

In some aspects, the techniques described herein relate to an emulsion, wherein the emulsion is clear.

In some aspects, the techniques described herein relate to an emulsion, wherein the emulsion is substantially free of a polysorbate. In some aspects, the techniques described herein relate to an emulsion, wherein the emulsion is substantially free of a weighting agent. In some aspects, the techniques described herein relate to an emulsion, wherein the sucrose ester or Quillaja saponaria extract is from 0.5 to 10 wt. %, the second emulsifier is from 0.1 to wt. 2%, and the functional ingredient is from 1 to wt. 10% of the emulsion. In some aspects, the techniques described herein relate to an emulsion, wherein the Quillaja saponaria extract is from 1 to 10 wt. %, the second emulsifier is from 0.1 to wt. 2%, and the functional ingredient is from 1 to 10 wt. % of the emulsion.

In some aspects, the techniques described herein relate to a beverage or beverage ingredient including the emulsion or formulation.

In some aspects, the techniques described herein relate to an emulsion, further including an anti-foaming agent.

In some aspects, the techniques described herein relate to an emulsion, further including propylene glycol, glycerol, or a combination thereof.

In some aspects, the techniques described herein relate to a method of adding the disclosed emulsions into a beverage stream.

In some aspects, the techniques described herein relate to a formulation for forming a beverage, including: a beverage base and an emulsion including a sucrose ester, a second emulsifier, and a water-insoluble functional ingredient, wherein the emulsion is present in the beverage base at from 0.15 to 30 wt. %. In some aspects, the techniques described herein relate to a formulation for forming a beverage, including: a beverage base and an emulsion including a Quillaja saponaria extract, a second emulsifier, and a water-insoluble functional ingredient, wherein the emulsion is present in the beverage base at from 0.15 to 30 wt. %.

In some aspects, the techniques described herein relate to a formulation, wherein the functional ingredient is selected from the group consisting of an antioxidant, flavor, colorant, and mouth feel enhancer.

In some aspects, the techniques described herein relate to a formulation, wherein the sucrose ester includes sucrose monoester.

In some aspects, the techniques described herein relate to a formulation, wherein the second emulsifier includes lecithin. In some aspects, the techniques described herein relate to a formulation, wherein the lecithin is derived from a plant. In some aspects, the techniques described herein relate to a formulation, wherein the plant belongs to genus Helianthus. In some aspects, the techniques described herein relate to a formulation, wherein the plant is Helianthus annuus.

In some aspects, the techniques described herein relate to a formulation, wherein the lecithin is derived from soybean, sunflower, canola, egg yolk, liver, dairy, meat, avocados, cabbage, or any mixture thereof. In some aspects, the techniques described herein relate to a formulation, wherein the water-insoluble functional ingredient includes vitamin E, fish oil, beta-carotene, vitamin D, or a mixture thereof. In some aspects, the techniques described herein relate to a formulation, wherein the vitamin E includes D-α-tocopherol, DL-α-tocopheryl acetate, or a combination thereof.

In some aspects, the techniques described herein relate to a formulation, wherein the emulsion is a micro-emulsion. In some aspects, the techniques described herein relate to a formulation, wherein the emulsion is a nano-emulsion.

In some aspects, the techniques described herein relate to a formulation, wherein the formulation is stable for at least 8 weeks at a temperature of 40° C. without forming a ring or separating.

In some aspects, the techniques described herein relate to a formulation, wherein the formulation is clear.

In some aspects, the techniques described herein relate to a formulation, wherein the formulation is substantially free of a polysorbate. In some aspects, the techniques described herein relate to a formulation, wherein the formulation is substantially free of a weighting agent.

In some aspects, the techniques described herein relate to a formulation, wherein the sucrose ester or Quillaja saponaria extract is from 0.5 to 10 wt. %, the second emulsifier is from 0.1 to wt. 2%, and the water insoluble functional ingredient is from 1 to 10 wt. % of the emulsion.

In some aspects, the techniques described herein relate to a formulation, wherein the formulation can be reconstituted at a ratio of from 3:1 to 1000:1 or the formulation can be reconstituted at a reconstitution rate of from 0.01% to 6%.

In some aspects, the techniques described herein relate to a beverage or beverage ingredient including the formulation and a diluent.

In some aspects, the techniques described herein relate to a formulation, further including an anti-foaming agent.

In some aspects, the techniques described herein relate to a formulation, further including propylene glycol, glycerol, or a combination thereof.

In some aspects, the techniques described herein relate to a method of dispensing a predetermined amount of the formulation into a beverage stream or diluent.

In some aspects, the techniques described herein relate to a method, wherein the formulation has a reconstitution ratio of 3:1 to 1000:1.

In some aspects, the techniques described herein relate to a method, wherein the formulation is used at a reconstitution rate of from 0.01% to 6%.

### Examples

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Vitamin E

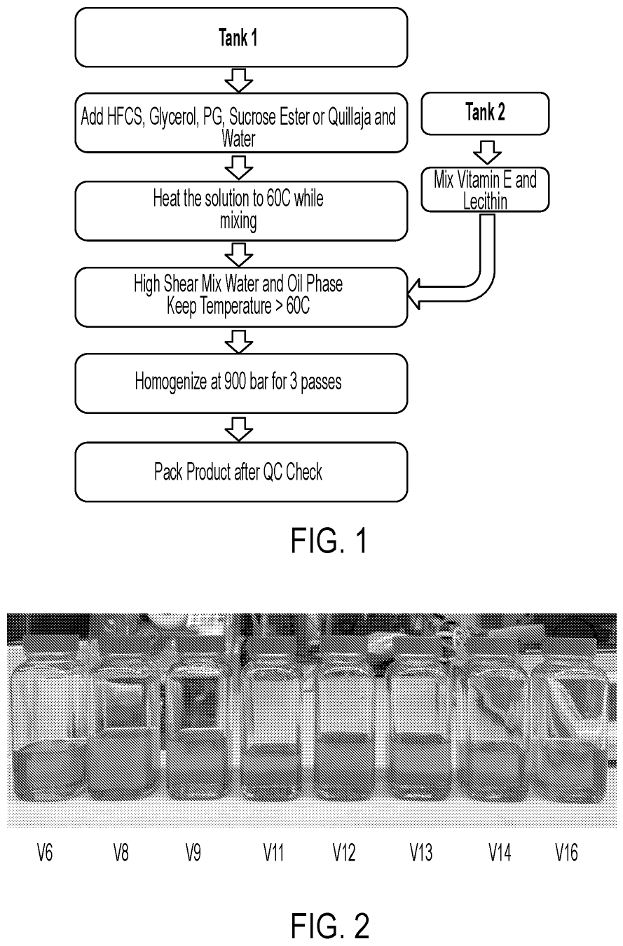

Various trial emulsions with vitamin E were prepared and tested as detailed in Tables 1-5. (See also FIG. 1.)

TABLE 1
Summary Results of Vitamin E Nano-Emulsion Trials (V6-V13): Ingredients are weighed in grams.

| | V6 Ctrl | V8 | V9 | V11 | V12 | V13 |
|---|---|---|---|---|---|---|
| Ingredient | Control | Trial | Trial | Trial | Trial | Trial |
| dl-α-Tocopheryl Acetate | 4.725 | 4.725 | 4.725 | 4.725 | 4.725 | 4.725 |
| Sunflower lecithin | 0.51 | 0.51 | 0.51 | 0.51 | 0.51 | 0.51 |
| Sucrose ester | 1.9 | 1.9 | 1.9 | 1.9 | 1.9 | 1.9 |
| Propylene Glycol | 15 | 15 | 15 | 35 | 51 | 70 |
| Glycerol | 23 | 23 | 23 | 16 | 0 | 0 |
| water | | 10 | 5 | | | |
| HFCS | 54.865 | 44.865 | 49.865 | 41.865 | 41.865 | 22.865 |
| Total | 100 | 100 | 100 | 100 | 100 | 100 |
| Observations | clear | cloudy | slightly | clear | clear | clear |
| | | | cloudy | | | |
| Viscosity @ 20 C (cP) | 2275 | | 1092 | 1569 | 2002 | 2163 |
| Viscosity @ 50 C (cP) | 315 | | 138 | 203 | 265 | 215 |
| Density | 1.28083 | 1.23902 | | 1.2614 | | |
| Nano analyzer size (nm) | 112.3 | 127.2 | 105.9 | | | 96.4 |
| Conclusion | | more cloudy, | much lower | lower | no | no changes |
| | | lower density, | viscosity, | viscosity | changes in | in viscosity |
| | | larger particle | slightly | | viscosity | |
| | | size | cloudier | | | |

All trials look very similar to control, except the second sample looks cloudier (10% water). See FIG. 2.

TABLE 2
Summary Results of Vitamin E Nano-Emulsion Trials (V14-V20)

| | V14 | V15 (C1) | V16 (C2) | V17 | V18 | V19 | V20 |
|---|---|---|---|---|---|---|---|
| Ingredient | Trial | Control | Control | Trial | Trial | Trial | Trial |
| dl-α-Tocopheryl Acetate | 4.725 | 4.725 | 4.725 | 4.725 | 4.725 | 4.725 | 4.725 |
| Sunflower lecithin | 0.51 | 0.51 | 0.51 | 0.51 | 0.51 | 0.51 | 0.51 |
| Sucrose ester Type 1 | 1.9 | 1.9 | 1.9 | | | | |
| Sucrose ester - Type 2 | | | | 1.9 | | | |
| Sucrose ester - Type 3 | | | | | 1.9 | | |
| Sucrose ester - Type 4 | | | | | | 1.9 | |
| Sucrose ester - Type 5 | | | | | | | 1.9 |
| Propylene Glycol | 51 | 15 | 15 | 15 | 15 | 15 | 15 |
| Glycerol | 0 | 23 | 23 | 23 | 23 | 23 | 23 |
| water | 5 | | | | | | |
| HFCS | 36.865 | 54.865 | 54.865 | 54.865 | 54.865 | 54.865 | 54.865 |
| Total | 100 | 100 | 100 | 100 | 100 | 100 | 100 |
| Observations | clear | clear | clear | clear | clear | slightly | clearest |
| | | | | | | cloudy | |
| Viscosity @ 20 C (cP) | 1117.6 | 979.7 | 1676.5 | 1942.5 | 1931.8 | 1960.1 | 2160.4 |
| Viscosity @ 30 C (cP) | 510.3 | 448.6 | 1145 | 1062 | 1080 | 1099 | 1508 |
| Viscosity @ 50 C (cP) | 132.6 | 121.1 | 260.6 | 215.1 | 250.1 | 225.7 | 249.5 |
| Density | | | | 1.28253 | 1.28232 | 1.28157 | 1.28511 |
| Nano analyzer size (nm) | 109.6 | 96.8 | | 109.9 | 102.5 | 102.4 | 96.7 |
| Conclusion | no changes | Control | Control | viscosity | viscosity | slightly | clearest |
| | in | | | increases | increases | cloudy, | appearance, |
| | viscosity | | | | | viscosity | viscosity |
| | | | | | | increases | increases |

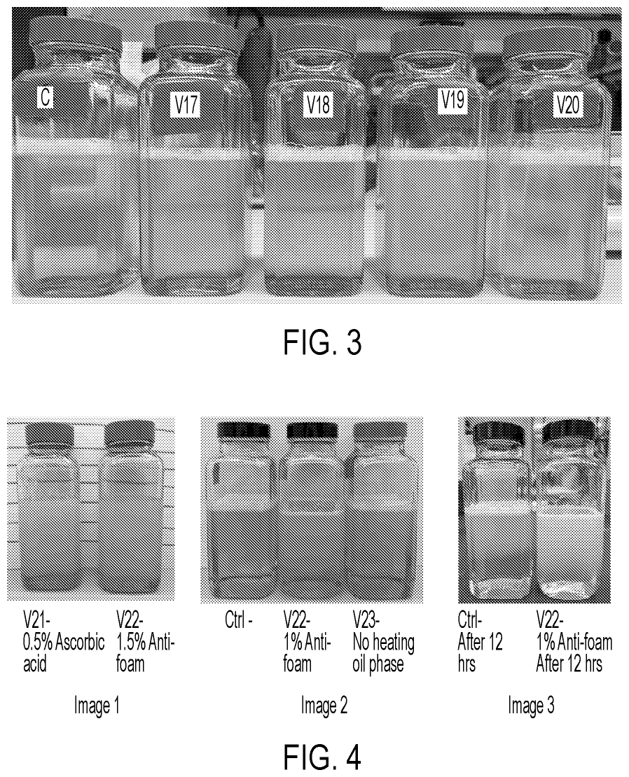

Five different types of sucrose esters (SE) were used (FIG. 9). SE had HLB values between 8 to 18 depending on types of fatty acids used and amount of esterification. V20 looks translucent, similar to control while V19 is the most cloudy. See FIGS. 2 and 3.

TABLE 3
Summary Results of Vitamin E Nano-Emulsion Trials (V21-V23)

| | V21 | V22 | V22 | C | V22 | V23 |
|---|---|---|---|---|---|---|
| Ingredient | Trial | Trial | Trial | Control | Trial | Trial |
| dl-α-Tocopheryl Acetate | 4.725 | 4.725 | 4.725 | 4.725 | 4.725 | 4.725 (no |
| | | | | | | heating) |
| Sunflower lecithin (0.45-1.0) | 0.51 | 0.51 | 0.51 | | | |
| Sunflower lecithin | | | | 0.51 | 0.51 | 0.51 (no |
| | | | | | | heating) |
| Sucrose ester Type 1 | 1.9 | 1.9 | 1.9 | 1.9 | 1.9 | 1.9 |
| Ascorbic Acid | 0.5% | | | | | |
| Anti-foaming agent | | 0.5% | 1.5% | | 1% | |
| Propylene glycol | 15 | 15 | 15 | 15 | 15 | 15 |
| Glycerol | 23 | 23 | 23 | 23 | 23 | 23 |
| water | | | | | | |
| HFCS | 54.365 | 54.365 | 53.365 | 54.865 | 53.865 | 54.865 |
| Total | 100 | 100 | 100 | 100 | 100 | 100 |
| Observations | cloudy | slight | cloudy | clear | clear | clear |
| | | cloudy | | | | |
| Viscosity @ 20 C (cP) | 2289 | 3289 | | 2459 | 2748 | 2354 |
| Viscosity @ 25 C (cP) | 121.1 | | | | | |
| Viscosity @ 30 C (cP) | | | | | | |
| Viscosity @ 50 C (cP) | 256 | 336 | | 236 | 331 | 276 |
| Density | 1.2797 | | | 1.28207 | | |
| Nano analyzer size (nm) | | | | | | |
| Conclusion | cloudy | foam did | cloudy | Control | more | result |
| | appearance, | not clear | appearance | | foam | similar to |
| | no viscosity | out, | | | than | control |
| | changes | increases | | | control | without |
| | | viscosity | | | | heating |
| | | | | | | oil phase |

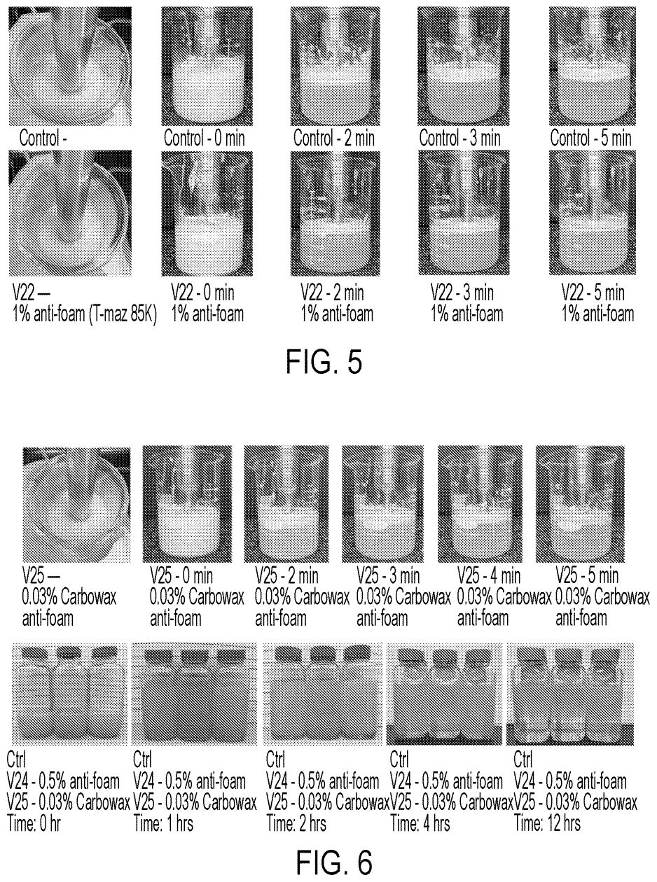

The product generates a lot of foaming. To reduce the amount of foaming, certain antifoaming agents were added into the emulsion. Antifoaming agents had higher surface activity which reduced the surface tension at interphase between foam's lamellae and air. Foam lost elasticity and ability to replenish it with water, causing defoaming. See FIG. 4. Sample with type 1 and type 2 anti-foams helped to reduce foams slightly when compared to control. Anti-foams caused some darker color change in the test samples. See FIG. 5.

TABLE 4
Summary Results of Vitamin E Nano-Emulsion Trials (V24-V25)

| | C | V24 | V25 | C | V14 | V15 |
|---|---|---|---|---|---|---|
| Ingredient | Control | Trial | Trial | Control | Trial | Trial |
| dl-α-Tocopheryl Acetate | 4.725 | 4.725 | 4.725 | 4.725 | 4.725 | 4.725 |
| Sunflower lecithin | 0.51 | 0.51 | 0.51 | 0.51 | 0.51 | 0.51 |
| Sucrose ester | 1.9 | 1.9 | 1.9 | 1.9 | 1.9 | 1.9 |
| Anti-foam | | 0.5% Type-1 | 0.03% Type-2 | | | |
| Propylene Glycol | 15 | 15 | 15 | 15 | 51 | 35 |
| Glycerol | 23 | 23 | 23 | 23 | 0 | 16 |
| water | | | | | 5 | 5 |
| HFCS | 54.865 | 54.365 | 54.835 | 54.865 | 36.865 | 36.865 |
| Total | 100 | 100 | 100 | 100 | 100 | 100 |
| Observations | clear | mostly clear | mostly clear | mostly clear | cloudy | cloudy |
| Conclusion | Control | Similar to | slightly | Control | more cloudy | more cloudy |
| | | control | more foams | | | |
| | | | than control | | | |

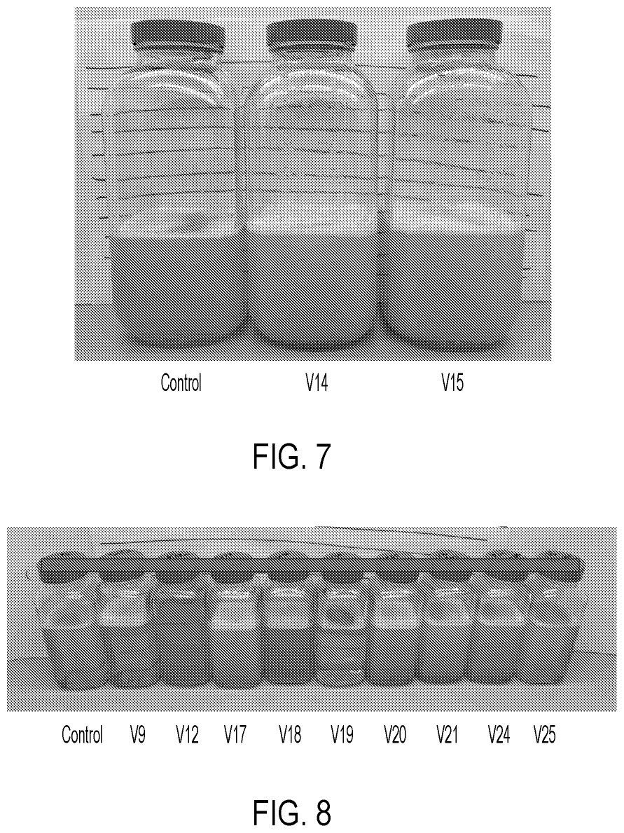

Carbowax anti-foam sample V25 at 0.03% did not perform as well as control and V24 0.5% anti-foam samples. See FIG. 6 After 3 days, control and V14 and V15 test samples at large volumes were still very cloudy, did not turn translucent. See FIG. 7.

TABLE 5
Summary Results of Vitamin E Nano-Emulsion Trials with fresh Propylene glycol (V26-V34)

| | C | V9 | V12 | V17 | V18 | V19 | V20 | V21 | V24 | V25 |
|---|---|---|---|---|---|---|---|---|---|---|
| Ingredient | Control | Trial | Trial | Trial | Trial | Trial | Trial | Trial | Trial | Trial |
| dl-α-Tocopheryl Acetate | 4.725 | 4.725 | 4.725 | 4.725 | 4.725 | 4.725 | 4.725 | 4.725 | 4.725 | 4.725 |
| Sunflower lecithin | 0.51 | 0.51 | 0.51 | 0.51 | 0.51 | 0.51 | 0.51 | 0.51 | 0.51 | 0.51 |
| Sucrose ester Type 1 | 1.9 | 1.9 | 1.9 | | | | | 1.9 | 1.9 | 1.9 |
| Sucrose ester - Type 2 | | | | 1.9 | | | | | | |
| Sucrose ester - Type 3 | | | | | 1.9 | | | | | |
| Sucrose ester - Type 4 | | | | | | 1.9 | | | | |
| Sucrose ester - Type 5 | | | | | | | 1.9 | | | |
| Ascorbic Acid | | | | | | | | 0.5% | | |
| Anti-foam | | | | | | | | | 0.5% Type 1 | 0.03% Type 2 |
| Propylene Glycol | 15 | 15 | 51 | 15 | 15 | 15 | 15 | 15 | 15 | 15 |
| Glycerol | 23 | 23 | 0 | 23 | 23 | 23 | 23 | 23 | 23 | 23 |
| water | | 5 | | | | | | | | |
| HFCS | 54.865 | 49.865 | 41.865 | 54.865 | 54.865 | 54.865 | 54.865 | 54.365 | 54.365 | 54.565 |
| Total | 100 | 100 | 100 | 100 | 100 | 100 | 100 | 100 | 100 | 100 |
| Observations | mostly | clear | very | cloudy | cloudy | clearest | cloudy | very | cloudy | cloudy |
| | clear | | cloudy | | | | | cloudy | | |
| Viscosity @ 20 C (cP) | | | | 2667 | | 2349 | 2754 | Too | 5341 | 6506 |
| | | | | | | | | viscous | | |
| Viscosity @ 25 C (cP) | 2042 | 773.3 | 1166 | 1708 | | 1506 | 1742 | Too | 4220 | 5113 |
| | | | | | | | | viscous | | |
| Viscosity @ 50 C (cP) | 276.7 | 132.3 | 83.6 | 238 | 312 | 216 | 238.7 | | 557.5 | 465.9 |
| Conclusion | Control | much | very | cloudier | cloudier | clearer | cloudier | very | more | more |
| | | lower | cloudy, | | | than | | cloudy, | cloudy, | cloudy, |
| | | viscosity, | much | | | control, | | too | higher | higher |
| | | slightly | lower | | | lower | | viscous | viscosity | viscosity |
| | | clearer | viscosity | | | viscosity | | | than | than |
| | | than | | | | | | | control | control |
| | | control | | | | | | | | |

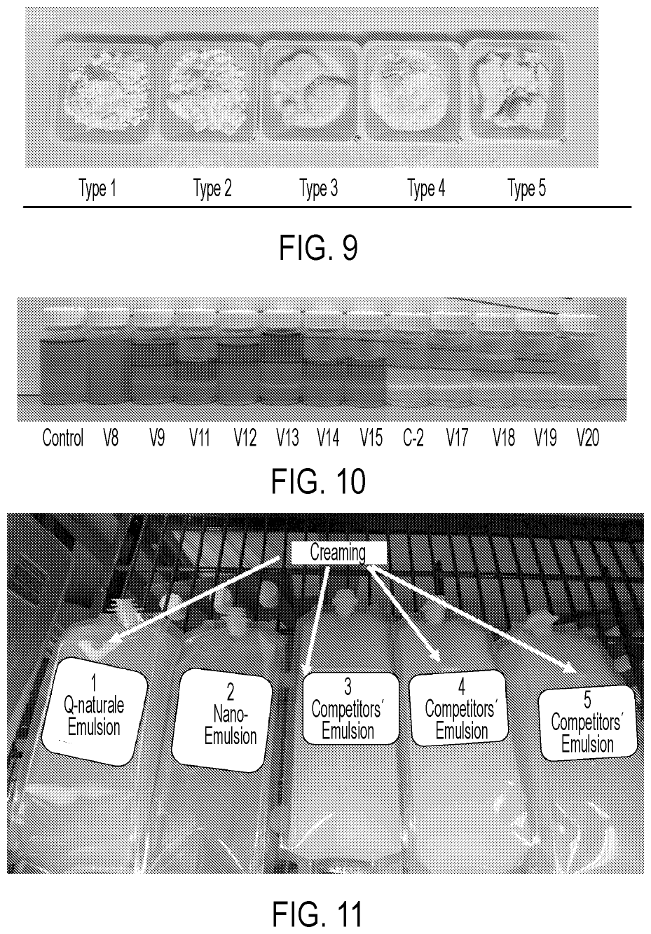

Trials V9 (5% water) and V19 (P90 Sucrose ester) were translucent with fresh Propylene glycol. The control was slightly hazy. Trial V21 (0.5% ascorbic acid) was very cloudy. No significant improvement was observed in trial V24 (Type 1) and trial V25 (Type 2) samples, compared to control. Trial V25 appeared more translucent than V24. See FIG. 8. Of all samples trial V8 (10% water) had lowest density with largest particle size.

In FIG. 10, the lighter yellow color trials were made with fresh HFCS. All trials were clear, similar to control except for V8 (10% water).

### Stability Studies

Example 1: Competitor's emulsion as shown in FIG. 11, pouch number 3. Product was Vitamin E, Dry, 15%, CC, with starch sodium octenyl succinate (E1450), dl-alpha-tocopheryl acetate (Vitamin E Acetate), and Silicon dioxide.

Example 2: Competitor's emulsion as shown in FIG. 11, pouch number 4. Product was 50% vitamin E powder encapsulated in maltrodextrin and modified food starch.

Example 3: 10% vitamin E emulsion made using 18% gum acacia.

| | |
|---|---|
| Gum Acacia | 6 |
| Oil | 10 |
| sorbate | 0.1 |
| benzoate | 0.1 |
| citric acid | 0.3 |
| water | 83.5 |
| total | 100 |

Example 4: Gum Ghatti and glycerol. This example is not shown in FIG. 11.

| | |
|---|---|
| dl-α-Tocopheryl Acetate | 6 |
| glycerine | 43 |
| gum Ghatti | 5 |
| L-ascorbic acid | 0.5 |
| citric acid | 0.4 |
| salts | 4 |
| edible oil | 0.6 |
| water | 40.5 |
| total | 100 |

Example 5: Q-naturale or Quillaja extract or saponins based emulsion. This emulsion is in pouch 1 in FIG. 11.

| | |
|---|---|
| oil | 4.5 |
| Medium chain triglycerides | 1 |
| lecithin | 0.51 |
| Q- naturale | 5 |
| PG | 15 |
| GL | 23 |
| HFCS | 51.99 |
| Total | 101 |

Five test emulsions were prepared as shown above. These emulsions were added to different pouches containing vitamins, minerals and other beverage actives as shown in the FIG. 11. Vitamin E emulsions were added at three different concentrations in this study: 150:1, 125:1 and 75:1, where 150:1 means vitamin E emulsion was added at 150 times concentration of what is used in the final beverage (10% recommended daily intake). Examples 1, 2, and 5 were used at 125, 150 and 125 times daily value. Each pouch contained 2 kg of product. Phosphoric acid at 1000 ppm was used to adjust pH of each to 3.07. The pouches were kept at 4° C., 30° C. and 40° C. for weeks and evaluated for physical instabilities such as creaming, sedimentation and color change.

Sucrose ester and lecithin-based vitamin E nano emulsion showed exceptional physical stability in the study. It passed very aggressing storage stability tests at 40° C. at high addition rate (a high addition rate is either 75, 125 or 150 times more than daily value of vitamin E of 15 mg/day). The particle size of emulsion was around 100 microns, making the emulsion transparent. Additionally, this emulsion did not require label un-friendly weighting agents.

The emulsion used in pouches 3, 4 and 5 made the product turbid (i.e., example 1 is in pouch 3, example 2 is in pouch 4, and example is in pouch 5). After 2 weeks of storage at 30° C. and 40° C., these pouches showed creaming on the top of the pouch. Q-Naturale based nano emulsion also showed creaming as shown in pouch 1.

Pouch 2 contained vitamin E nano emulsion at 125 times daily value. This pouch did not show any sediments or creaming even after stored at elevated temperatures for more than 2 months. Additionally, the pouch was transparent as the vitamin E particle size was below 100 nanometer.

### Flavor Oils

Flavor oil nanoemulsions were made with different flavor oil blends at 10% as shown in Table 6. All the flavor nanoemulsions were stored at ambient conditions for 6 months.

TABLE 6
Nanoemulsion formulation with different flavor oil blends (%).

| | |
|---|---|
| Flavor oil | 10 |
| Sucrose ester | 1.9 |
| Lecithin | 0.51 |
| Glycerol | 38 |
| HFCS | 49.59 |
| Total | 100 |

The nanoemulsion was incorporated into mock citric beverages at a concentration of 0.1% and the stability of the beverage was monitored over 6 months as shown in Table 7. Only Flavor nanoemulsion 1 showed slight ringing in horizontal bottles after 3 months, no ringing or sedimentation was observed for other samples.

TABLE 7
Physical stability of diet and regular mock beverages made with 0.1% flavor
oil nanoemulsion. Each beverage had two bottles of sample vertically
(Vert.) and horizontally (Hzntl.). Number 0 indicates no ringing, 1 indicates
neck ring visible with strong light and very close distance.

| | Flavor emulsion 1 | | Flavor emulsion 2 | | Flavor emulsion 3 | | Flavor emulsion 4 | |
|---|---|---|---|---|---|---|---|---|
| | Diet | Regular | Diet | Regular | Diet | Regular | Diet | Regular |
| 1 week | Vert. 0 | Vert. 0 | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 | Hzntl. 0 | Hzntl. 0 |
| 1 month | Vert. 0 | Vert. 0 | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 | Hzntl. 0 | Hzntl. 0 |
| 2 months | Vert. 0 | Vert. 0 | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 | Hzntl. 0 | Hzntl. 0 |
| 3 months | Vert. 0 | Vert. 0 | Vert. 0 | Vert. 0 | Vert. 0 | Vert. 0 | Vert. 0 | Vert. 0 |
| | Hzntl. 1 | Hzntl. 1 | Hzntl. 0 | Hzntl. 0 | Hzntl. 0 | Hzntl. 0 | Hzntl. 0 | Hzntl. 0 |
| 4 months | Vert. 0 | Vert. 0 | Vert. 0 | Vert. 0 | Vert. 0 | Vert. 0 | Vert. 0 | Vert. 0 |
| | Hzntl. 1 | Hzntl. 1 | Hzntl. 0 | Hzntl. 0 | Hzntl. 0 | Hzntl. 0 | Hzntl. 0 | Hzntl. 0 |
| 5 months | Vert. 0 | Vert. 0 | Vert. 0 | Vert. 0 | Vert. 0 | Vert. 0 | Vert. 0 | Vert. 0 |
| | Hzntl. 1 | Hzntl. 1 | Hzntl. 0 | Hzntl. 0 | Hzntl. 0 | Hzntl. 0 | Hzntl. 0 | Hzntl. 0 |
| 6 months | Vert. 0 | Vert. 0 | Vert. 0 | Vert. 0 | Vert. 0 | Vert. 0 | Vert. 0 | Vert. 0 |
| | Hzntl. 1 | Hzntl. 1 | Hzntl. 0 | Hzntl. 0 | Hzntl. 0 | Hzntl. 0 | Hzntl. 0 | Hzntl. 0 |

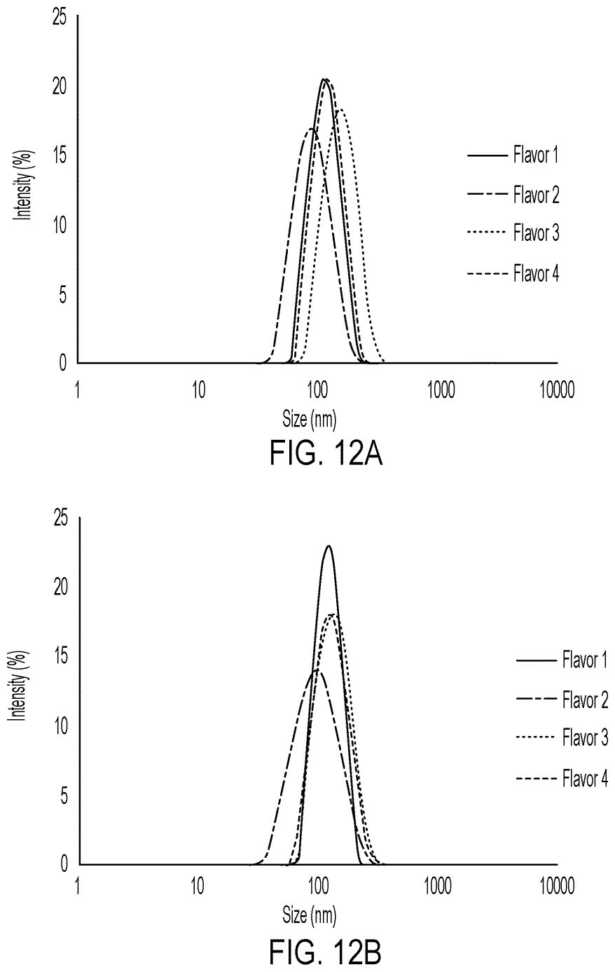

Since some 10% flavor oil nanoemulsions are not stable within 6 months, the concentration of flavor oil phase was reduced to 4-5%. Examples of size distribution of freshly made nanoemulsion are shown in FIG. 12A. The emulsions were stored at ambient conditions for 3-5 months, and no change in size was observed across all the three samples as shown in FIG. 12B.

Various trail nanoemulsion with one specific flavor oil were prepared and the turbidity of 0.1% nanoemulsion in mock diet beverage was measured as shown in Table 8. To reduce the turbidity of the beverages, a third emulsifier such as polyglycerol esters of fatty acids was also added. T2, T3, T6, T7, and T8 were selected to run beverage stability test as shown in Table 9 and Table 10. Trail T2 showed slight ringing on horizontal bottles at month 4, and T3 showed ringing starting from 1 week. All trails with third emulsifier T5-T8 didn't show any ringing or sedimentation.

TABLE 8
Turbidity of 0.1% nanoemulsion in mock diet beverages.

| | T1 | T2 | T3 | T4 | T5 | T6 | T7 | T8 |
|---|---|---|---|---|---|---|---|---|
| Flavor oil | 10% | 5% | 5% | 4.5% | 4.5% | 4.5% | 5% | 4.5% |
| Sucrose ester | 1.9% | 1.25% | 1.9% | 1.9% | 1.9% | 1.25% | 1.25% | 1.9% |
| Polyglycerol | | | | | 0.5% | 0.5% | 0.4% | 0.5% |
| ester of FA | | | | | | | | |
| Lecithin 1 | 0.51% | 0.25% | 0.51% | 0.51% | 0.1% | | | |
| Lecithin 2 | | | | | | 0.2% | 0.2% | 0.2% |
| Turbidity | 53.3 | 7.15 | 13.28 | 6.84 | 34.1 | 4.46 | 4.69 | 16.03 |

TABLE 9
Physical stability of diet and regular mock beverages made with 0.1%
flavor nanoemulsion. Each beverage has two bottles of sample vertically
(Vert.) and horizontally (Hzntl.). Number 0 indicates no ringing,
1 indicates neck ring visible with strong light and very close distance,
2 indicates neck ring visible at two feet distance.

| | T2 Diet | T3 Diet |
|---|---|---|
| 1 week | Vert. 0 | Vert. 0 |
| | Hzntl. 0 | Hzntl. 1 |
| 1 month | Vert. 0 | Vert. 0 |
| | Hzntl. 0 | Hzntl. 2 |
| 2 months | Vert. 0 | Vert. 0 |
| | Hzntl. 0 | Hzntl. 2 |
| 3 months | Vert. 0 | Vert. 0 |
| | Hzntl. 0 | Hzntl. 2 |
| 4 months | Vert. 0 | Vert. 0 |
| | Hzntl. 0 | Hzntl. 2 |
| 5 months | Vert. 0 | Vert. 0 |
| | Hzntl. 1 | Hzntl. 2 |

TABLE 10
Physical stability of diet and regular mock beverages made with 0.1%
flavor nanoemulsion. Each beverage has two bottles of sample vertically
(Vert.) and horizontally (Hzntl.). Number 0 indicates no ringing,
1 indicates neck ring visible with strong light and very close distance,
2 indicates neck ring visible at two feet distance.

| | T6 | | T7 | | T8 | |
|---|---|---|---|---|---|---|
| | Diet | Regular | Diet | Regular | Diet | Regular |
| 1 week | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |
| 1 month | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |
| 2 months | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |
| 3 months | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |
| 4 months | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |
| 5 months | Vert. 0 | Vert. 0 | Vert. 0 | Vert. 0 | Vert. 0 | Vert. 0 |
| | Hzntl. 0 | Hzntl. 0 | Hzntl. 0 | Hzntl. 0 | Hzntl. 0 | Hzntl. 0 |

### Mouth Feel Enhancers

Mouthfeel enhancers were made using different fats combinations. A few examples are shown in Table 11. Examples of fats include medium chain triglyercides, coconut oil, and fatty acids such as palmitic acid, stearic acid, myristic acid, oleic acid, lauric acid, and linolenic acid. Regardless of the fats used, the average diameter of the nanoemulsion was less than 100 nm. The oil phase used in these examples are at 3%, but it can be increased to 4.5%.

TABLE 11
Nanoemulsion formulation with different fats (%).

| | | | |
|---|---|---|---|
| Fats | 3 | 3 | 3 |
| Sucrose ester | 1.9 | 1.9 | 1.9 |
| Lecithin | 0.51 | 0.51 | 0.51 |
| Glycerol | 38 | 38 | 38 |
| HFCS | 56.59 | 56.59 | 56.59 |
| Total | 100 | 100 | 100 |

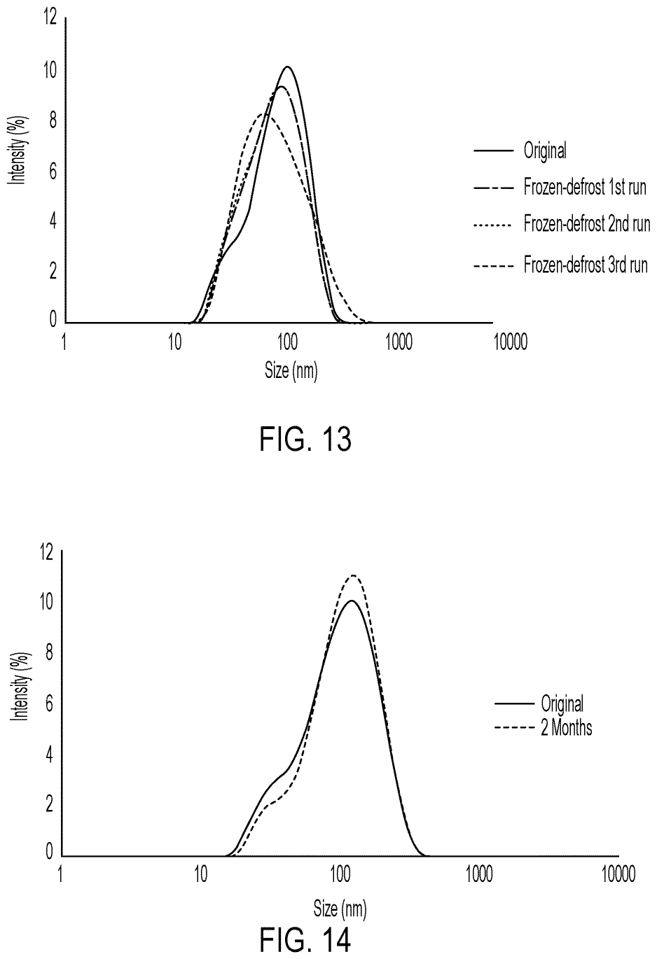

The stability of the nanoemulsions was evaluated using freeze-defrost circulated for a few times. Examples of change of size in nanoemulsion with fatty acids was shown in FIG. 13. Nanoemulsion was put in the freezer overnight and defrosted the next day, the change in size distribution was captured.

Nanoemulsions were stored at ambient condition and the change in size was monitored over time. FIG. 14 shows the size distribution of freshly made nanoemulsion and after 2 months storage.

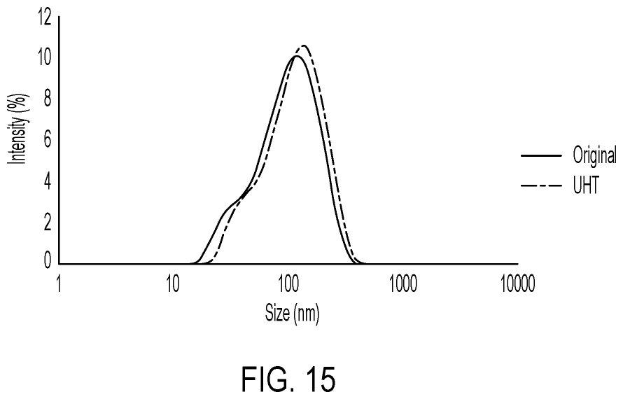

Considering that a main application of mouthfeel enhancers is in coffee, tea, juice, and protein beverages, which usually undergo thermal processing, a mouth feel enhancer nanoemulsion (using fatty acids) at 0.1% in water was treated with UHT with direct steam injection. The size change before and after UHT are shown in FIG. 15. The data show no significant change in size after UHT.

The methods and compositions of the appended claims are not limited in scope by the specific methods and compositions described herein, which are intended as illustrations of a few aspects of the claims and any methods and compositions that are functionally equivalent are intended to fall within the scope of the claims. Various modifications of the methods and compositions in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A formulation for forming a beverage, comprising: a beverage base and an emulsion comprising a sucrose ester, a second emulsifier, and a water-insoluble functional ingredient, wherein the emulsion is present in the beverage base at from 0.15 to 30 wt. %.

2. The formulation of claim 1, wherein the water-insoluble functional ingredient is selected from the group consisting of an antioxidant, flavor, colorant, and mouth feel enhancer.

3. The formulation of claim 1, wherein the sucrose ester comprises sucrose monoester.

4. The formulation of claim 1, wherein the second emulsifier comprises lecithin.

5. The formulation of claim 4, wherein the lecithin is derived from a plant.

6. The formulation of claim 5, wherein the plant belongs to genus Helianthus.

7. (canceled)

8. The formulation of claim 4, wherein the lecithin is derived from soybean, sunflower, canola, egg yolk, liver, dairy, meat, avocados, cabbage, or any mixture thereof.

9. The formulation of claim 1, wherein the water-insoluble functional ingredient comprises vitamin E, fish oil, beta-carotene, vitamin D, or a mixture thereof.

10. The formulation of claim 9, wherein the vitamin E comprises D-α-tocopherol, DL-α-tocopheryl acetate, or a combination thereof.

11. The formulation of claim 1, wherein the emulsion is a micro-emulsion or a nano-emulsion.

12. (canceled)

13. The formulation of claim 1, wherein the formulation is stable for at least 8 weeks at a temperature of 40° C. without forming a ring or separating.

14. (canceled)

15. (canceled)

16. The formulation of claim 1, wherein the formulation is substantially free of a weighting agent or a polysorbate.

17. The formulation of claim 1, wherein the sucrose ester is from 0.5 to 10 wt. %, the second emulsifier is from 0.1 to wt. 2%, and the water-insoluble functional ingredient is from 1 to 10 wt. % of the emulsion.

18. The formulation of claim 1, wherein the formulation can be reconstituted at a ratio of from 3:1 to 1000:1 or the formulation can be reconstituted at a reconstitution rate of from 0.01% to 6%.

19. A beverage or beverage ingredient comprising the formulation of claim 1 and a diluent.

20-37. (canceled)

38. The formulation of claim 1, further comprising an anti-foaming agent.

39. The formulation of claim 1, further comprising propylene glycol, glycerol, or a combination thereof.

40. A method of preparing a beverage, comprising dispensing a predetermined amount of the formulation of claim 1 into a beverage stream or diluent.

41. The method of claim 40, wherein the formulation has a reconstitution ratio of 3:1 to 1000:1.

42. The method of claim 40, wherein the formulation is used at a reconstitution rate of from 0.01% to 6%.
